(19) United States
(12) Patent Application Publication
(10) Pub. No.: US 2003/0099220 A1
(43) Pub. Date: May 29, 2003

(54) Routing of client data service and packet data service

(75) Inventor: Hyo Sig Jeon, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/300,878

(22) Filed: Nov. 21, 2002

(30) Foreign Application Priority Data
Nov. 27, 2001 (KR) 74306/2001

(51) Int. Cl. H04Q 7/00

(52) U.S. Cl. 370/338; 370/352; 370/328

(57) ABSTRACT

Embodiments of the present invention relate to a method which may include at least one of the following steps. Receiving a call at a base station. Determining the type of the call. Routing, at the base station, the call according to the type of the call. A user of a mobile terminal may initiate browsing the Internet on the cell phone. When the base station receives this call, it will route the call to the Internet directly from the base station. Likewise, when a user is trying to place a call which is a voice conversation, the base station will route the call to a telephone network. The present invention are advantageous, as calls of different types can be routed at the base station, so that all data is handled in a most appropriate manner. This is advantageous, as there is less likelihood of a change the data will be lost, due to the discrimination of data calls and voice calls. Further, elimination of dependency of a wireless communication system on a telephone network for data services improves the reliability, efficiency, and effectiveness of a mobile communication system offering data services.

### BACKGROUND OF THE INVENTION

1. Field of the Invention

The present invention relates to wireless communication systems.

2. Background of the Related Art

Mobile radio communication systems are used in everyday life. Garage door openers, remote controllers for home entertainment equipment, cordless telephones, hand-held walkie-talkies, pagers, and cellular telephones are all examples of mobile radio communication systems. Cellular radio systems provide high quality service that is often comparable to that of a landline telephone system. Over time, cellular radio systems have continued to evolve. In fact, third generation wireless networks (often referred to as 3G) are currently being developed. The goal of 3G wireless networks is for “cellular phones” to have both voice and data capabilities (such as internet browsing capabilities).

Mobile radio communication systems, which handle both voice and data capabilities, are not always efficiently operated. For instance, a mobile radio communication system may route both voice and data in the same manner. However, voice communications and data communications can be very different. Accordingly, because voice and data are handled the same way, problems occur. In some instances data is lost in the mobile radio communication system. Further, sometimes the data services of a mobile communication system are unnecessarily slow, which is undesirable to an end user.

### SUMMARY OF THE INVENTION

Objects of the present invention are to at least overcome the disadvantages of the related art. Embodiments of the present invention relate to a method. The method may include the following steps. Receiving a call at a base station. Determining the type of the call. Routing, at the base station, the call according to the type of the call.

A base station is a component of a wireless communication system that communicates with a mobile terminal using radio signals. Typically, a base station is connected by wire to a larger communication network. For example, a mobile terminal (i.e., cell phone) may wirelessly communicate with a base station. The base station may then continue the communication through a wired network connected to the base station.

A type of a call may be the type of service that a user of a mobile terminal is requesting. For example, a user may be browsing the Internet on their cell phone; this type of call may be packet data service. Likewise, a user may be using a cell phone to have a voice conversation; this kind of communication may be circuit data service.

Routing is the task of connecting a call to the appropriate network. Accordingly, embodiments of the present invention connect, at a base station, a call made from a mobile terminal, depending on the type of call. For example, a user of a mobile terminal may initiate browsing the Internet on their cell phone. When the base station receives this call, it will route the call to the Internet directly from the base station. Likewise, when a user is trying to place a call which is a voice conversation, the base station will route the call at the base station to a telephone network.

Embodiments of the present invention are advantageous, as calls of different types can be routed at the base station, so that all data is handled in an efficient manner. This is advantageous, as there is less likelihood that data will be lost, due to the discrimination of data calls and voice calls. Further, elimination of dependency of a wireless communication system on a telephone network for data services improves the reliability, efficiency, and effectiveness of a mobile communication system offering voice and data services.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary illustration of a network configuration of a WLL V5.2 system.

FIG. 2 is an exemplary illustration of a configuration of packet data service within a WLL V5.2 system.

FIG. 3 is an exemplary flow chart of call establishment between an Access Network and Local Exchange.

FIG. 4 is an exemplary illustration of an allocation complete message structure in a WLL V5.2 system.

FIG. 5 is an exemplary illustration of a network configuration of a WLL V5.2 system.

FIG. 6 is an exemplary flow chart of providing packet data service in a WLL V5.2 system.

FIG. 7 is an exemplary illustration of an allocation complete message structure of a V5.2 interface.

### DETAILED DESCRIPTION OF PREFERRED EMBODIMENTS

A Wireless Local Loop (WLL) system is a phone system for connecting wirelessly, without using existing phone-lines, to subscriber lines within a predetermined area of a base station. It may be cheaper and easier to implement a WLL system than a wired telephone system. A WLL system may be implemented anywhere that radio waves can reach. This allows for flexible construction of communication networks. WLL systems may be developed with similarities to a subscriber network. An Access Network (AN) supports wireless service as well as existing wired exchange networks. A WLL system may provide wireless services which include voice, fax, Integrated Services Digital Network (ISDN), and circuit data services that are also provided in wired networks.

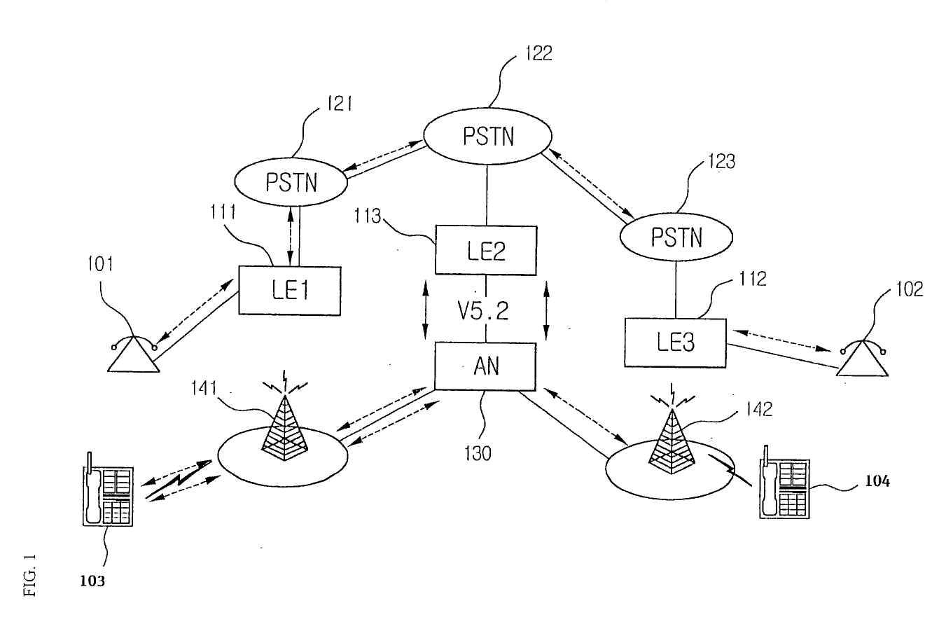

FIG. 1 is an exemplary illustration of a WLL system supporting V5.2 (WLL V5.2, hereinafter). The WLL system may include an AN 130 for connecting to wireless subscribers 103, 104 through competent base stations 141, 142. A WLL may include Local Exchanges (LEs) 111, 112, 113 for inter-working with Public Switched Telephone Network (PSTN) 122 in order to construct call paths for wired subscribers 101, 102. A WLL may also include a V5.2 interface for interfacing AN 130 with first and third LE 111, 112. A V5.2 interface can be replaced with R2/No7 or another comparable interface.

First and third LEs 111,112 interface wired subscribers 101,102 with PSTNs 121, 122, 123 to provide wired phone service. Second LE 113 interfaces PSTN 122 with AN 130 via V5.2 to provide a wired phone line. AN 130 supports wireless connection service to wireless subscribers 103, 104 via competent base stations 141, 142. A WLL system including AN 130 may accommodate existing wired networks. It may provide services between wireless subscribers or between a wireless and wired subscribers. It may provide wireless services including voice, fax, and circuit data services.

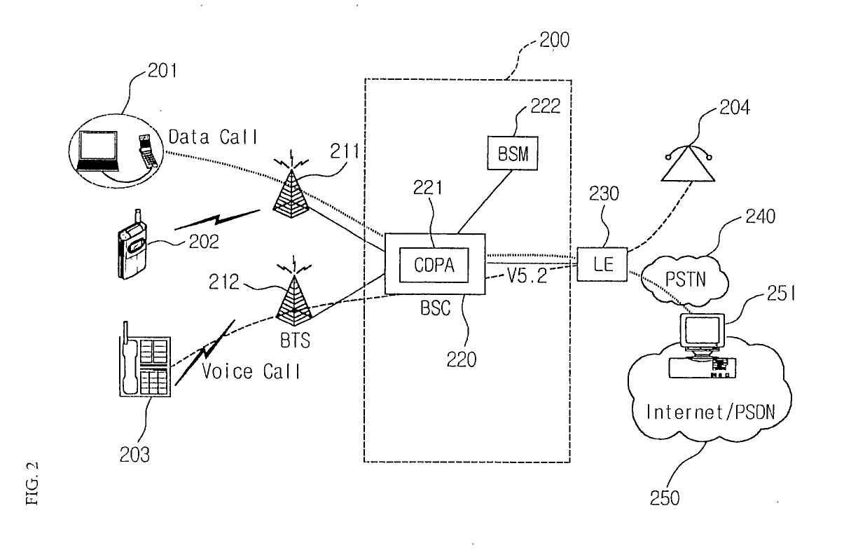

FIG. 2 is an exemplary illustration of a configuration of packet data service within a WLL V5.2 system. A circuit data processor, (i.e., a Circuit Data Processing Assembly (CDPA)) may be included in a Base Station Controller (BSC) 220, which may be placed inside an AN 200, in order to serve data calls such as a Fax or a Circuit provided in the related wired networks. BSC 220 manages wireless resources of base stations 211, 212. AN 200 transfers port numbers allocated to the corresponding subscribers to the LE 230, when voice and data calls of the subscribers 201, 203 are received via the base stations 211, 212. In other words, the LE 230 manages the subscribers port by port, and the AN 200 identifies each number of the subscribers 201, 202, and 203. AN 200 transforms each destination number into Dual Tone Multi-Frequency (DTMF) tone to enable LE 230 to process and transfer DTMF tones. BSC 220 in AN 200 may interface with LE 230 via V5.2. LE 230 may analyze a tone of a voice call, interfaces with a wired subscriber by constructing a phone call connecting the voice call to a destination subscriber, and interfaces the data call with a server on an Internet/Packet Switched Data Network (PSDN) 250 via PSTN 240.

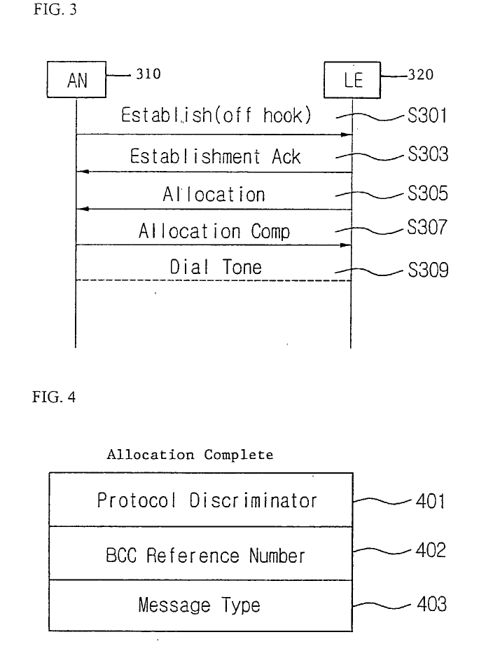

FIG. 3 is an exemplary illustration of a channel establishment process between an AN and a LE. AN 310 may request a call establishment to LE 320 (step 301) and may receive a call establishment ACK signal in response to the call establishment request from the LE 320 (step S303). LE 320 may generate an allocation message in order to allocate a Bearer channel and transfers it to AN 310 (step S305). AN 310 may then transmit a channel allocation complete message to LE 320 (step S307). AN 310 and LE 320 may construct a wired phone path between them in dial tone (step S309).

A call may be established via a protocol using a message according to V5.2 interface specifications. FIG. 4 is an exemplary illustration of content of a channel allocation complete message transmitted from AN 310 to LE 320, where the content includes a protocol discriminator 401, Bearer Channel Collection (BCC), reference number 402, and a message type 403.

Protocol discriminator 401 discriminates whether the message is a message related to call establishment. If the message is not related to call establishment (i.e., fault or status-related message), the content of the protocol discriminator 401 is replaced. The protocol discriminator 401 allows for anticipation of other information in a channel allocation complete message. BCC reference number 402 is a connection channel information set at the time of call establishment. Depending on circumstances, a specific BCC can be used in case of exclusive use of a signal or each different BCC may be allocated. Message type 403 indicates a type of message. After a corresponding message type is discriminated as one of call establishment request and call establishment ACK, remaining information of a channel allocation complete message may be processed.

In the exemplary WLL V5.2 system illustrated in FIGS. 1-4, there is no function of managing status related to packet data for subscribers requesting packet data service call. Since the LE may not be configured to process a packet data service call, the system may not be able to appreciate the subscriber's packet data status. For example, circuit data (i.e., telephone call) and a fax data each include a destination number (i.e., phone number). An AN may generate DTMF tones corresponding to the destination number information and transfer the destination number to a LE. The LE analyses the DTMF tones, constructs phone lines to subscribers having the destination numbers and then provides corresponding services. However, when a LE provides data service in the WLL system, illustrated in FIGS. 1-4, the system can process only circuit data owing to a circuit-based network. Accordingly, problems may occur in transmission of packet data.

Packet data services, (i.e., Internet or File Transfer Protocol (FTP), etc.) may have no destination number. A LE may refuse to establish calls for packet data due to problems of processing destination numbers. Since information indicating that a subscriber requested packet data services cannot be transferred to a LE, the LE may refuse the call. For instance, if a subscriber requests packet data service, the V5.2 WLL system, illustrated in FIGS. 1-4, may not transfer call information. Subsequently, the LE cannot process the call, process information on the subscriber requesting the packet data service, or appreciate if the subscriber is using packet data service. Further, service option information processed by a terminal and the AN cannot be transferred to the LE due to the V5.2 interface specification. Therefore, additional packet data service cannot be processed.

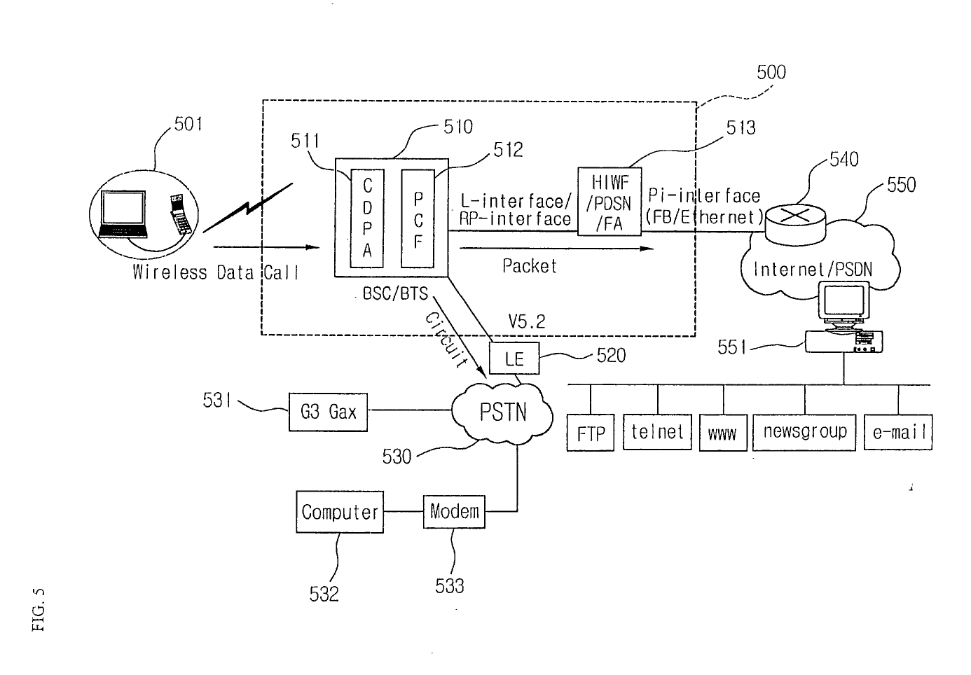

FIG. 5 illustrates a WLL V5.2 system including an AN 500, a LE 520, a router 540, Internet/PSDN 550, and an ISP host 551. AN 500 may be for providing information on status and management of packet data service for a wireless subscriber 501 requesting the packet data service and establishing a path for the packet data service. LE 520 may be for interfacing with AN 500 to identify the packet data service and inter-work with PSTN for circuit data service. Router 540 may be for routing a packet path of AN 500. Internet/PSDN 550 may be for transmitting data in a packet unit. ISP host 551 may be for providing web service on the Internet.

AN 500 may include a base station/BSC 510 including CDPA 511 for circuit data service and a Packet Control Function (PCF) 512 for transferring packets. AN 500 may include a packet service node (High Inter-Working Function (HIWF)/Packet Data Serving Node (PDSN)/Foreign Agent (FA)) 513 for connecting a path of the PCF 512 to the Internet. Base station/BSC 510 may process circuit data for a wireless subscriber 501 using CDPA 511. Base station/BSC 510 may support packet service for a wireless subscriber 501 using PCF 512. Base station/BSC 510 may undertake a call identification procedure by interfacing with LE 520 via a V5.2 interface. Base station/BSC 510 may interface with packet service node (HIWF/PSDN/FA) 513 via radio protocol interface (RP-Interface) and with a exchange-network inter-working device (MSC-IWF) via L-interface to re-establish a packet path between PCF 512 and packet service node 513.

In embodiments, there are procedures for call identification and packet path establishment for a subscriber requesting the packet service. When the AN 500 receives a request for wireless data call service from a wireless subscriber 501, it may confirm service request information of the wireless subscriber 501, may identify the subscriber with information from LE 520 in case of the packet data service, and/or may establish a dedicated packet path to provide service within the corresponding serviced area. An identifying procedure between AN 500 and LE 520 is to interface between them via V5.2 interface and establish a call via a protocol of a message defined by the interface specification. AN 500 may then add service option information to the V5.2 interface message and transfers it to the LE 520.

A V5.2 allocation complete message may include a protocol discriminator 601, BCC reference number 602, a message type 603, and/or a service option 604. Protocol discriminator 601 discriminates whether a message is a message related to call establishment. If the message is not related to call establishment (i.e., fault or status-related message), the content of the protocol discriminator 401 may be replaced. Protocol discriminator 601 allows for anticipation of other information in a channel allocation complete message. BCC reference number 602 is a connection channel information set at the time of call establishment. Depending on circumstances, a specific BCC may be used in case of exclusive use of signal or each different BCC can be allocated. Message type 603 indicates a type of message. After the corresponding message type being discriminated as one of call establishment request or call establishment ACK, other information of an allocation complete message may be processed. Service option 604 indicates that the service option requested by the wireless subscriber is the packet service request information. LE 520 may inter-work only for identifying a wireless subscriber using packet data service.

After AN 500 completes identification of a subscriber requesting packet data service, packet data service packets may not pass through a packet data path via LE 520. However, a dedicated packet path via the packet service node 513 may be established and may include an internal PCF 512, a network inter-working device, and/or a packet data serving node. AN 500 may then route to an optimal path using router 540 and may service packet data through ISP host 551 in Internet/PSDN 550. The PCF 512 may transfer the packet data and HIWF/PDSN/FA of the packet service node 513 may provide Internet connection service. Through these paths the packet service may be provided.

When processing data calls, the HIWF and/or PDSN of packet service node 513 may establish packet paths through modem emulation or packet network connection. FA may decapsulate IP packets of a mobile terminal to transmit, linking with the mobile terminal, when the mobile terminal visits a visiting network (i.e., roaming). AN 500 may include a PCF, IWF, and/or PDSN for packet service and may reestablish a dedicated packet path to provide packet service within a corresponding service area. LE 520 may charge identified subscribers who request the packet data service. The charges may be divided into time charge and/or packet frame charge. A WLL system that has an AN 500 including a PCF, IWF, and/or PDSN, may establish a dedicated packet path. The dedicated packet path may not pass through LE 520 to provide packet service to subscribers. LE 520 may perform only inter-working for identifying subscribers in packet data service.

FIG. 7 illustrates exemplary embodiments of the present invention of packet data service in a WLL V5.2. When a call request for a subscriber is received through the PSTN user port, AN 710 may generate a call establishment message in order to initialize PSTN path and may transmit the call establishment message to LE 720 (step S701). LE 720 may receive a call establishment message from the AN 710 and may initialize a PSTN path and insert results of the initialization into a call establishment ACK message to transmit it to AN 710 (step S703). LE 720 may generate an allocation message to allocate a Bearer channel and transmits it to AN 710 (step S705). AN 710 may receive an allocation message from LE 720, may allocate a Bearer channel (step S707), may insert a result of allocation into an allocation complete message, and may then transmit the allocation complete message to LE 720.

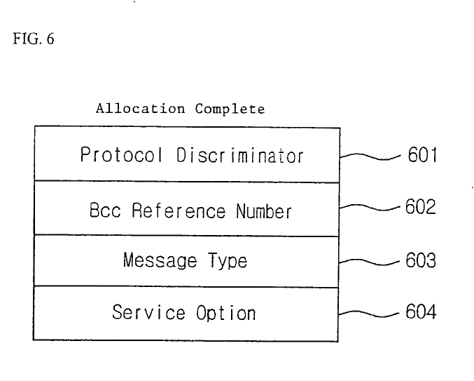

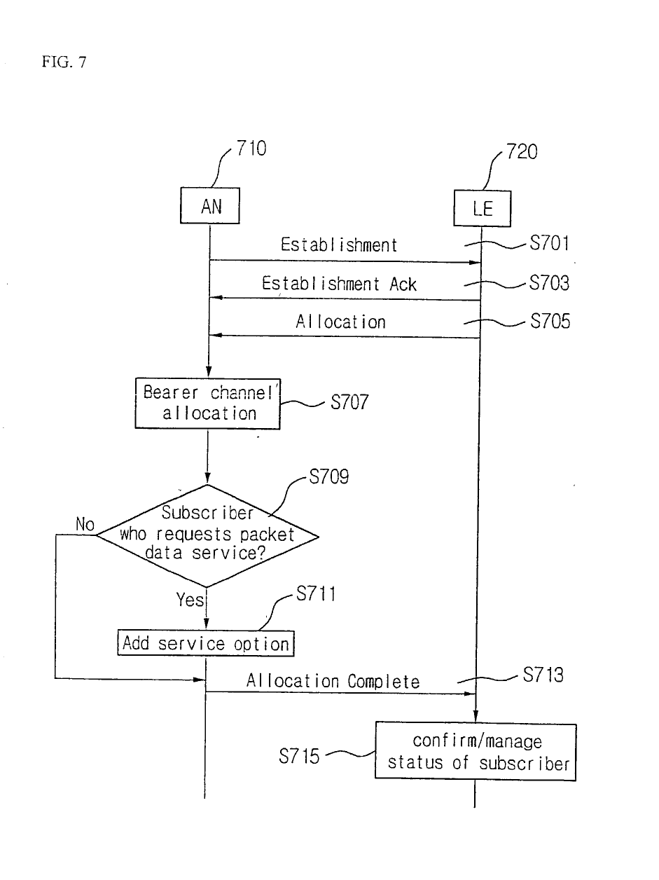

AN 710 may confirm if a wireless subscriber requests packet data service (step S709). If so, it may add a service option (step S711) and provide an allocation complete message, including the service option, to LE 720 (step S713). Structure of an allocation complete message may include, as illustrated in FIG. 6, protocol discriminator 601, BCC reference number 602, message type 603, and/or service option 604. Service option information requested by a subscriber may be added to a V5.2 interface message by adjusting the V5.2 specification.

AN 710 may confirm if a subscriber requesting a call is requesting packet data service (step S709). AN 710 may then add the confirmed information into a service option field of an allocation complete message (step S711). An 710 may then insert the result of Bearer channel allocation into an allocation complete message and transmits it the LE 720 (step S713). LE 720 may receive an allocation complete message from AN 710. LE 720 may confirm and manage status of the subscriber, who uses the packet data service, through a service option included in the allocation complete message (step S713). Subscribers may be charged for packet data service and provided functions of additional packet data services (i.e., process of idle state or packet paging).

Embodiments of the present invention relate to a compromise between AN 500 and LE 520 (illustrated in FIG. 5). The compromise may be a specific destination number that enables the packet data service. AN 500 may transfer a specific destination number to LE 520 for a subscriber, who requests packet data service. Compromise related to a process of service establishment between AN 500 and LE 520 enables delivering the destination number transmitted to LE 520 to a specially designated service number, which indicates that the call is to request the packet data service. Special service numbers (i.e., #777, 999*, etc.) may be set as destination numbers in order to indicate that a subscriber requests packet data service by compromising between the AN 500 and LS 520.

When a call request is received from a subscriber via a PSTN user port, AN 500 may initialize PSTN paths, may allocate a Bearer channel, and may confirm that the subscriber requesting the call is the subscriber requesting the packet data service. AN 500 may generate a DTMF tone for pre-set special service numbers together with a destination number in time of tone transformation of destination numbers and transfers it the LE 520. LE 520 may analyze a received DTMF tone to perform destination number connection, may confirm status of the subscriber, and may support charging the subscriber for the packet data service. Additional packet data services (i.e., process of idle state or packet paging, etc.) may also be supported.

Accordingly, it is an object of the present invention to provide a WLL system for providing information on status and management of packet data service, while supporting packet data service for subscribers requesting packet data service calls. It is the other object of the present invention to provide a method for charging wireless subscribers for the packet data service in the WLL system. It is another object of the present invention to provide a method for adding a fact that the packet data service is requested by wireless subscribers to a message of V5.2 interface in AN and transferring the message to a LE. It is another object of the present invention to provide a method for providing additional packet data service, i.e., idle process or packet paging process in the WLL system. To achieve the above object, there is provided a WLL system comprising: an access network for identifying a wireless subscriber who requests a packet data service, establishing a packet data path for the identified subscriber; a local exchange for inter-working with a PSTN for a wired service, inter-working with the access network for identification and managing a status of the packet data service for the wireless subscriber; and an interfacing means for interfacing between the access network and the local exchange to transfer a packet data service option.

Here, the interfacing means is V5.2 interface. The access network includes a base station/base station controller which comprises a circuit data processor assembly for processing circuit data and a packet control function for a packet transfer; and a service node which comprises a packet data serving node and a network inter-working device for establishing dedicated packet path between the packet control function and Internet/PSDN. The access network adds packet data service option information to a V5.2 interface message and transfers the same to the local exchange in case that the wireless subscriber is a subscriber who requests the packet data service. The packet data service option information for the subscriber who requests the packet data service is added to a Bearer channel allocation complete message and the same is transferred to the local exchange.

The allocation complete message of the V5.2 interface comprises a protocol discriminator for discriminating information whether the message is related to the call establishment, a BCC reference number for indicating information on connection channel established in time of call establishment, a message type for indicating the types of a call establishment request message and a call establishment ACK message and service option information indicating a specific service option requested by the subscriber. The local exchange charges the wireless subscriber using the status information on the subscriber who requests the packet data service. In another aspect of the present invention, there is provided a WLL system comprising: a WLL access network which comprises a circuit data processor for providing circuit data service, a packet control function for supporting a packet data service and a packet service node; and a local exchange for allocating channels according to the circuit data service and a specific service option via the WLL access network and V5.2 interface, and manages status of the subscribers. The V5.2 interface comprises a channel allocation complete message including a protocol discriminator, a BCC reference number, a message type and a service option for indicating a status of the packet data service.

In yet another aspect of the present invention, there is provided a method of serving a packet data in a WLL system, comprising the steps of: transmitting, at an access network received call request from a wireless subscriber, a call establishment request message to a local network and receiving a response to a call establishment request message; receiving a Bearer channel allocation message from the local exchange, completing the allocation of the Bearer channel and confirming that the call request from the wireless subscriber is a request for the packet data service; and adding a service option to the allocation complete message and transmitting the same to the local exchange if the call request is the request for the packet data service. The local exchange verifies and manages status of the wireless subscriber, after receiving the allocation complete message to which the service option added.

In further another aspect of the present invention, there is provided a method of serving a packet data in a WLL system, comprising the steps of: pre-establishing a special service number indicating that a call is the one of a subscriber who requests packet data service according to compromise between an access network and a local exchange; transmitting, at the access network, a call establishment message to the local exchange whether the call is requested and receiving a response to the message from the local exchange; receiving, at the access network, a Bearer channel allocation message according to the call establishment from the local exchange and allocating the Bearer channel; confirming, at the access network, that the service requested by the subscriber is the packet data service after the channel allocation; generating DTMF tone corresponding to the pre-established special service number and transmitting the DTMF tone to the local exchange in case that the subscriber requests the packet data service; and the local exchange analyzing the DTMF tone, confirming and managing a status of the subscriber, and connecting to a destination number.

According to the present invention, the WLL system provides information on status and management of the packet data service for subscribers, while supporting the packet data service. The WLL system also adds information related to corresponding packet data service to a message of the present specified V 5.2 interface between the AN and LE or transfers information on designated destination number. Therefore, the WLL system can provide service of management to status of subscribers of packet data service, support to charge subscribers utilizing packet data service, and provide additional packet data service.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising:
receiving a call at a base station;
determining a type of the call; and
routing, at the base station, the call according to the type of the call.

2. The method of claim 1, wherein the base station comprises a base station controller.

3. The method of claim 1, wherein the type of the call is at least one of circuit data service and packet data service.

4. The method of claim 3, wherein:
circuit data service utilizes a public switched telephone network; and
packet data service utilizes a packet switched data network.

5. The method of claim 1, wherein the step of routing the call according to the type of the call comprises:
routing the call to a local exchange, if the type of the call is a circuit data service; and
routing the call to a packet service node, if the type of the call is packet data service.

6. The method of claim 5, wherein:
the routing the call to the local exchange is through a circuit data processing assembly; and
the routing the call to the packet service node is through a packet control function.

7. The method of claim 5, wherein the packet service node comprises at least one of:
a high inter-working function;
a packet data serving node; and
a foreign agent.

8. The method of claim 1, comprising determining the subscriber of the call at a local exchange.

9. The method of claim 1, wherein, if the type of the call is packet data service, then the routing comprises communicating from the base station to a local exchange that the type of the call is packet data service.

10. The method of claim 9, wherein the local exchange is configured to communicate with the base station and a public switched telephone network.

11. The method of claim 10, wherein communication between the local exchange and the base station is through at least one of WLL system supporting V5.2 protocol and WLL R2/No7 protocol.

12. The method of claim 9, wherein the communicating is in a service option field of an allocation complete message.

13. An apparatus configured to:
receive a call at a base station;
determine a type of the call; and
route, at the base station, the call according to the type of the call.

14. The apparatus of claim 13, wherein the base station comprises a base station controller.

15. The apparatus of claim 13, wherein the type of the call is at least one of circuit data service and packet data service.

16. The apparatus of claim 15, wherein:
circuit data service utilizes a public switched telephone network; and
packet data service utilizes a packet switched data network.

17. The apparatus of claim 13, wherein the route of the call according to the type of the call comprises:
routing the call to a local exchange, if the type of the call is a circuit data service; and
routing the call to a packet service node, if the type of the call is packet data service.

18. The apparatus of claim 17, wherein:
the routing the call to the local exchange is through a circuit data processing assembly; and
the routing the call to the packet service node is through a packet control function.

19. The apparatus of claim 17, wherein the packet service node comprises at least one of:
a high inter-working function;
a packet data serving node; and
a foreign agent.

20. The apparatus of claim 13, configured to determine the subscriber of the call at a local exchange.

21. The apparatus of claim 13, wherein, if the type of the call is packet data service, then the route comprises communicating from the base station to a local exchange that the type of the call is packet data service.

22. The apparatus of claim 21, wherein the local exchange is configured to communicate with the base station and a public switched telephone network.

23. The apparatus of claim 22, wherein communication between the local exchange and the base station is through at least one of WLL system supporting V5.2 protocol and WLL R2/No7 protocol.

24. The method of claim 21, wherein the communicating is in a service option field of an allocation complete message.
